(19) United States
(12) Patent Application Publication
(10) Pub. No.: US 2024/0308472 A1
(43) Pub. Date: Sep. 19, 2024

(54) Wiper Blade Wear Indicator and System

(71) Applicant: Illinois Tool Works Inc., Glenview, IL (US)

(72) Inventor: Martin William Rosas, Cypress, TX (US)

(21) Appl. No.: 18/590,126

(22) Filed: Feb. 28, 2024

Related U.S. Application Data
(60) Provisional application No. 63/452,478, filed on Mar. 16, 2023.

(51) Int. Cl. B60S 1/38

(52) U.S. Cl. CPC B60S 1/38; B60S 2001/3827; B60S 2001/3844

(57) ABSTRACT

Described is a wiper blade for a windshield of a vehicle. The wiper blade having a frame structure, a squeegee, and a conductive strip. The squeegee is coupled to the frame structure and includes a wiping lip. The conductive strip is formed on a side wall of the wiping lip. The conductive strip extends along a length of the wiping lip. The wiper blade can also include an indicator, such as one or more light emitting diodes, to indicate a physical condition of the wiping lip.

### RELATED APPLICATION

The present application claims priority to U.S. Provisional Patent Application No. 63/452,478, filed Mar. 16, 2023, and entitled “Wiper Blade Wear Indicator and System,” which is hereby incorporated by reference in its entirety.

### BACKGROUND

Windshield wipers are used to remove rain, snow, ice, washer fluid, water, and/or other debris from a vehicle's front or rear windshield. Almost all vehicles are equipped with one or more windshield wipers, including cars, trucks, buses, train locomotives, watercraft (e.g., those with a cabin) and even some aircraft. In many jurisdictions, windshield wipers are a legal requirement.

Vehicles use a variety of wiper blade types and configurations, but a common objective for all wiper blade types is that they conform to the surface and/or contour of the glass upon which they are mounted (whether a front or rear windshield) to effectively clear the windshield. Over time, the wiping surface of the wiper blade's squeegee that contacts the windshield (the wiping lip) begins to degrade due to mechanical wear. Such degradation results in less effective wiping, streaks, and the like.

Currently, there is no indicator for physical wear on wiper blades that is directly correlated to the mechanical wear of the wiping lip. Instead, existing wear indicators consider ultraviolet (UV) exposure rather the mechanical wear that the wiper blade experiences. While UV exposure is an indicator of wear, UV exposure cannot accurately account for wiper blades that are used frequently and yet have limited UV exposure. That is, during a given time frame, a wiper blade that is used very frequently would wear down faster than one used seldomly; however, the UV wear indicator would not be able to distinguish between such wiper blades if they are exposed to the same amount of UV.

Despite advancements to date, a need exists for a wiper blade and wiper blade system that is not dependent on pre-determined milestones, but rather on physical condition of the wiping lip. For example, a wiper blade and wiper blade system configured to detect mechanical wear or damage to the wiping lip of a wiper blade in real-time or near real-time.

### SUMMARY

The present disclosure relates generally to an improved wiper blade, substantially as illustrated by and described in connection with at least one of the figures, as set forth more completely in the claims. More specifically, the present disclosure relates to a wiper blade and wiper blade system that is not dependent on pre-determined milestones, but rather on physical condition of critical performance element. More specifically, a wiper blade and wiper blade system configured to detect mechanical wear or damage to the wiping lip of a wiper blade in real-time or near real-time.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an example vehicle having a windshield and a pair of wiper blades.

FIG. 1b illustrates an assembly view of an example connection point between the wiper blade and the wiper arm.

FIGS. 2a and 2b illustrate perspective side and end views of a wiper blade in accordance with an aspect of the present disclosure.

FIGS. 2c and 2d illustrate, respectively, binary and incremental indicators in accordance with aspects of the present disclosure.

FIGS. 3a and 3b illustrate, respectively, schematic representations of an example binary-output blade wear circuit in a first state and a second state.

FIG. 4 illustrates a schematic representation of a variable-output blade wear circuit in accordance with another aspect of the present disclosure.

FIG. 5 illustrates a schematic representation of a blade-wear system in accordance with an aspect of the present disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The terms “communicate” and “communicating” as used herein, include both conveying data from a source to a destination and delivering data to a communications medium, system, channel, network, device, wire, cable, fiber, circuit, and/or link to be conveyed to a destination. The term “communication” as used herein means data so conveyed or delivered. The term “communications” as used herein includes one or more of a communications medium, system, channel, network, device, wire, cable, fiber, circuit, and/or link.

The terms “coupled,” “coupled to,” and “coupled with” as used herein, each mean a relationship between or among two or more devices, apparatuses, files, circuits, elements, functions, operations, processes, programs, media, components, networks, systems, subsystems, and/or means, constituting any one or more of: (i) a connection, whether direct or through one or more other devices, apparatuses, files, circuits, elements, functions, operations, processes, programs, media, components, networks, systems, subsystems, or means; (ii) a communications relationship, whether direct or through one or more other devices, apparatuses, files, circuits, elements, functions, operations, processes, programs, media, components, networks, systems, subsystems, or means; and/or (iii) a functional relationship in which the operation of any one or more devices, apparatuses, files, circuits, elements, functions, operations, processes, programs, media, components, networks, systems, subsystems, or means depends, in whole or in part, on the operation of any one or more others thereof.

The term “data” as used herein means any indicia, signals, marks, symbols, domains, symbol sets, representations, and any other physical form or forms representing information, whether permanent or temporary, whether visible, audible, acoustic, electric, magnetic, electromagnetic, or otherwise manifested. The term “data” is used to represent predetermined information in one physical form, encompassing any and all representations of corresponding information in a different physical form or forms.

The term “network” as used herein includes both networks and inter-networks of all kinds, including the Internet, and is not limited to any particular network or inter-network.

The term “processor” as used herein means processing devices, apparatuses, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing.

Wiper blades used in vehicles vary in size and shape. In some cases, wiper blades can be the same shape, but will vary in size. While wiper blades are most often associated with automobiles (e.g., cars, trucks, etc.), they are likewise employed in numerous other vehicles, such as trains, watercraft, and aircraft. Therefore, the following disclosure should not be limited to wiper blades and wiper arms used in automobiles, but rather would be applicable to wiper blades and wiper arms used in any type of vehicle.

The present disclosure relates to a wiper blade and wiper blade system configured to detect mechanical wear or damage to the wiping lip of a wiper blade in real-time or near real-time. In one example, a wiper blade comprises: a frame structure, a squeegee, and a conductive strip. The squeegee is coupled to the frame structure and comprises a wiping lip. The conductive strip is formed on a side wall of the wiping lip and extends along a length of the wiping lip.

In some examples, the wiper blade further comprises an indicator configured to indicate a physical condition of the wiping lip. In some examples, the wiper blade further comprises a power source configured to pass power through the conductive strip. In some examples, the wiper blade further comprises a resistor (R1) connected electrically in series with the indicator, the indicator and the resistor (R1) being connected electrically in parallel with each of the power source and the conductive strip. In another example, the wiper blade comprises a resistor (R2) connected electrically in series with the conductive strip to form a voltage divider with a power source. In some examples, the conductive strip is arranged to shunt the indicator and the resistor (R1).

In another example, a blade-wear system comprises: a wiper blade, a processor, and an indicator. The wiper blade comprises a squeegee and a conductive strip formed on a wiping lip of the squeegee. The conductive strip extends along a length of the wiping lip. The processor is configured to determine a physical condition of the wiping lip as a function of a resistance value of the conductive strip. The indicator is configured to indicate the physical condition of the wiping lip. The processor can be configured to determine the physical condition of the wiping lip in real time or near-real time. Further, the indicator can be configured to indicate the physical condition of the wiping lip in a binary manner. In some examples, the wiper blade further comprises a resistor (R1) connected electrically in series with the indicator, the indicator and the resistor (R1) being connected electrically in parallel with each of a power source and the conductive strip.

The indicator may comprise a light emitting diode (LED). In some examples, at least the wiping lip is replaceable. In some examples, the conductive strip comprises a conductive material comprising at least one of carbon, graphene, or carbon nanotube.

In some examples, the wiper blade further comprises a resistor (R2) connected electrically in series with the conductive strip to form a voltage divider with a power source. In some examples, the indicator is configured to indicate the physical condition of the wiping lip in an incremental manner. In some examples, the wiper blade comprises the indicator. In some examples, the processor is configured to communicate, via a wireless device, an indication of the physical condition to a portable user device.

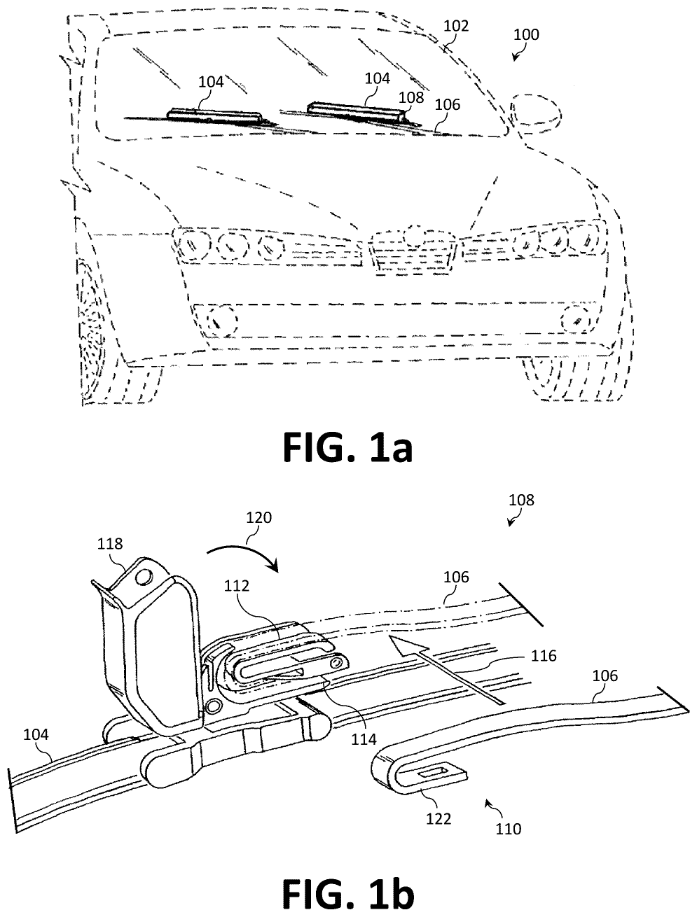

FIG. 1a illustrates an example vehicle 100 having a windshield 102 and a pair of wiper blades 104. As illustrated, each wiper blade 104 is removably coupled to a wiper arm 106 of the vehicle 100 via a coupling 108. As is known in the art, the wiper arms 106 (and, therefore, the wiper blades 104) are configured to translate back and forth across the windshield 102 to clear the windshield 102 of rain, snow, and debris via one or more electric motors and mechanical linkages associated with the vehicle 100.

FIG. 1b illustrates an assembly view of an example coupling 108 between the wiper blade 104 and the wiper arm 106. As illustrated, each wiper arm 106 includes or otherwise defines, at its distal end, an arm-side connector 110. The arm-side connector 110 is configured to engage and secure the wiper blade 104 via a complimentary blade-side connector 112 positioned on or otherwise associated with the wiper blade 104. In the illustrated example, the arm-side connector 110 is inserted into a J-shaped slot 114 of the blade-side connector 112 as indicated by arrow 116. Once assembled, a locking cap 118 can be folded as indicated by arrow 120 (e.g., pivoted about a hinge) and positioned to cover, secure, and protect the connected arm-side connector 110 and blade-side connector 112. In the illustrated example, the wiper arm 106 includes an arm-side connector 110 configured a J-Hook connector 122, but other connector types are contemplated.

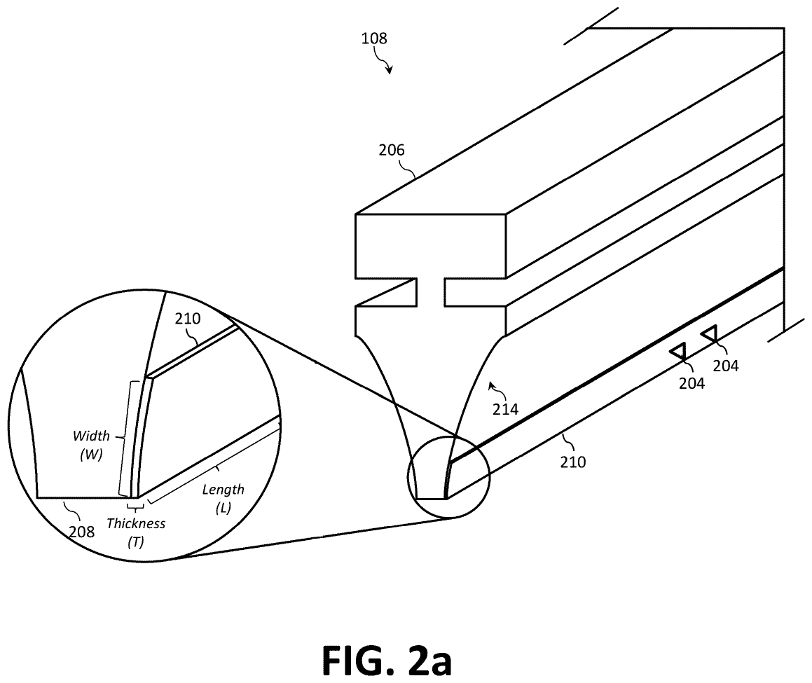

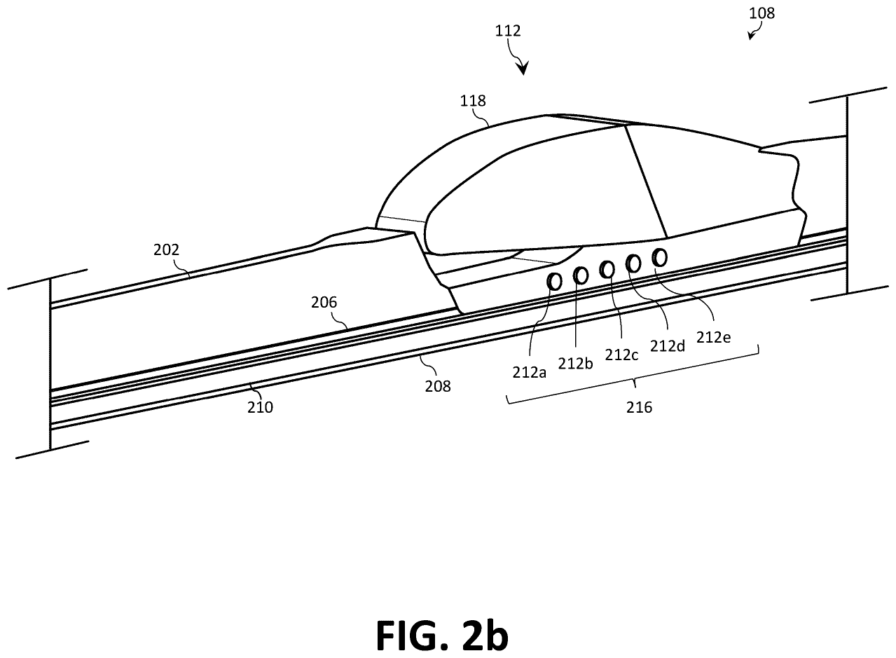

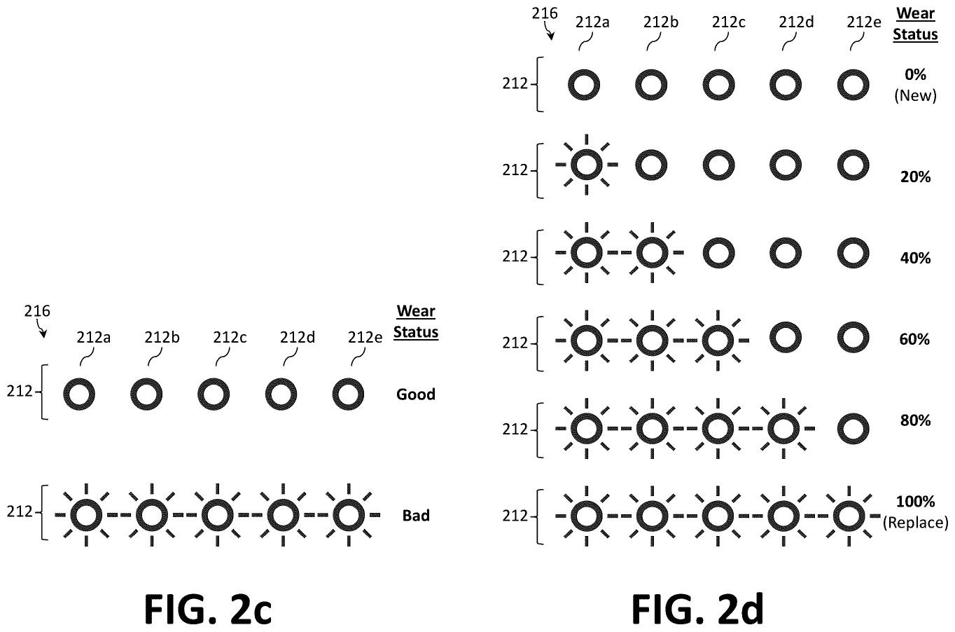

FIGS. 2a and 2b illustrate perspective side and end views of a wiper blade 104 in accordance with an aspect of the present disclosure. The wiper blade 104 generally comprises a frame structure 202, a squeegee 206, and a wiping lip 208. FIGS. 2c and 2d illustrate, respectively, binary and incremental indicators for use with the wiper blade 104 in accordance with aspects of the present disclosure.

The windshield wiper blade 104 and components thereof (e.g., the frame structure 202, the squeegee 206, and/or wiping lip 208) can be fabricated from one or more elastomeric materials. Example elastomeric materials include, for example, thermoplastic polyurethane (TPU), thermoplastic vulcanizates (TPV), thermoplastic elastomers (TPE), flexible polyurethane (FPU), silicon, etc. The frame structure 202 is configured to couple to the wiper arm 106 via the blade-side connector 112 of the coupling 108. The blade-side connector 112 may be integral with the frame structure 202 or attached thereto via one or more fasteners, adhesives, etc.

In some examples, two or more components of the windshield wiper blade 104 can be formed from the same material and/or as a single, integrated component. For example, the squeegee 206 and the wiping lip 208 could be fabricated as a single component. In some examples, the windshield wiper blade 104 (or a portion thereof) can be a printed plastic material component (e.g., thermoplastic, TPU, FPU, etc.) . . . . Printed plastic material components can be printed with great accuracy and with numerous details, which is particularly advantageous, for example, in creating components requiring complex and/or precise features. In addition, additive manufacturing techniques obviate the need for mold tooling, thereby lowering up-front manufacturing costs, which is particularly advantageous in low-volume productions. In some examples, the windshield wiper blade 104 may be fabricated using material extrusion (e.g., fused deposition modeling (FDM)), stereolithography (SLA), selective laser sintering (SLS), material jetting, binder jetting, powder bed fusion, directed energy deposition, VAT photopolymerisation, and/or any other suitable type of additive manufacturing/3D printing process.

As illustrated in FIGS. 2a and 2b, the wiper blade 104 includes a conductive strip 210 that can be used to determine wear or damage 204 to the wiping lip 208. The conductive strip 210 can be provided in the form of a conductive coating, film, or tape. The conductive strip 210 can be applied to the wiping lip 208 as a paint, spray, or laminate. For example, the conductive strip 210 can be formed from an electrically conductive paint or paste, which is made by mixing an electrically conductive material into a non-conductive resin binder. A number of electrically conductive materials can be used, including metals (e.g., copper, silver, nickel, etc.) and non-metals (e.g., carbon, graphene, carbon nanotubes, etc.).

As best illustrated in FIG. 2a, the conductive strip 210 has a width (W), a thickness (T), and a length (L). The width (W), thickness (T), and length (L) will vary depending on the size of the wiping lip 208. In the illustrated example, the conductive strip 210 is positioned at the apex of the wiping lip 208 and extends over a lower portion of the side wall 214 of the wiping lip 208. The lower portion may be, for example, 5% to 75% of the side wall 214, 15% to 50% of the side wall 214, or about 25% of the side wall 214. The length (L) will depend on the vehicle 100 as the length of a wiper blade 104 (and thus the length of the conductive strip 210) will vary depending on the type of vehicle. The length (L) may be, for example, between 11 and 28 inches. The cross-sectional area (A) of the conductive strip 210 can be determined using the following equation:

Cross-Sectional Area(A)=Width(W)*Thickness(T)

In some examples, a coating may be applied over the wiping lip 208 and the conductive strip 210 to mitigate the effects of the environment. For example, the coating may be a non-stick coating and/or non-conducting coating that mitigate the effects of debris on the electrical properties of the conductive strip 210 by either easily brushing the debris away or electrically isolating the debris from the conductive strip 210.

With reference to FIG. 2b, the wiper blade 104 further comprises one or more indicators 216, which may be in the form of light emitting diodes (LEDs), liquid crystal displays (LCDs), or the like. The one or more indicators 216 can be positioned on the frame structure 202, the blade-side connector 112, or elsewhere on the wiper blade 104 such that the one or more indicators 216 are visible to the operator of the vehicle 100 (e.g., through the windshield). For example, the illustrated wiper blade 104 includes, as its indicators 216, five LEDs 212 (a first LED 212a, a second LED 212b, a third LED 212c, a fourth LED 212d, and a fifth LED 212e) at the blade-side connector 112 (i.e., below the locking cap 118).

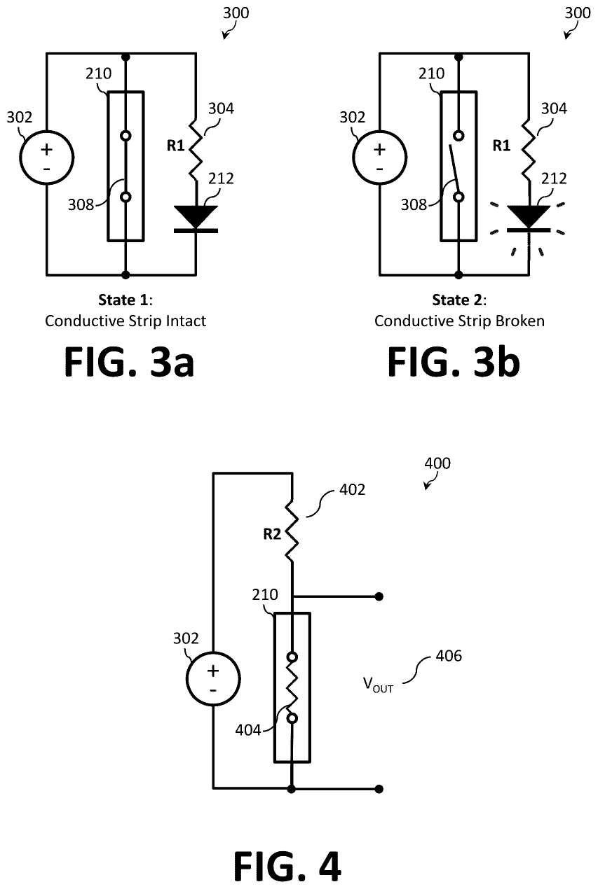

Regardless of the chosen physical configuration or location, the one or more indicators 216 can be configured to indicate whether the wiping lip 208 is damaged or a magnitude of damage. As will be discussed in connection with FIGS. 3a, 3b, and 4, a measured resistance value of the conductive strip 210 can be used to determine whether the wiping lip 208 is damaged or the extent of any damage. In some examples, the squeegee 206 and/or the wiping lip 208 can be configured as a replaceable component (e.g., a consumable) such that the frame structure 202, the one or more indicators 216, and/or other components can be reused to save materials and money.

As illustrated in FIG. 2c, in one example, the LEDs 212 can indicate, in a binary manner, that the wiping lip 208 is either bad (e.g., damaged and is due for replacement) or is good (e.g., acceptable for continued use). In this example, each of the LEDs 212 may be illuminated (e.g., in red) when the wiping lip 208 is bad and not illuminated (i.e., off) when the wiping lip 208 is good (e.g., to conserve power). Where power conservation is not critical, it is contemplated, however, that the LEDs may be illuminated in a second, different color (e.g., in green, blue, etc.) when the wiping lip 208 is deemed to be good (e.g., via a processor or other circuit). The wiping lip 208 can be determined to be bad when the wear to the wiping lip 208 (as determined by a measured resistance value of the conductive strip 210) exceeds a predetermined threshold.

As illustrated in FIG. 2d, in another example, the LEDs 212 can indicate, in an incremental manner (e.g., akin to a bar graph), a degree of damage to the wiping lip 208. In this example, each of the LEDs 212 is not illuminated (i.e., off) when the wiping lip 208 is not damaged (i.e., a new wiping lip 208 with 0% damage) to conserve power, and the LEDs 212 can be incrementally illuminated one-by-one as the wiping lip 208 becomes increasingly damaged (e.g., in 20% increments) until each of the LEDs 212 is illuminated at 100% wear—signaling a replacement is needed. The wear of the wiping lip 208 can be determined when the measured resistance value of the conductive strip 210 exceeds predetermined thresholds (e.g., for the illustrated example, thresholds associated with 20%, 40%, 60%, and 80% wear).

In this example, the LEDs 212 can each be the same color (e.g., red) or a gradient of colors can be used. For example, at 20% wear, the first LED 212a can illuminated in yellow, but as additional LEDs 212 are illuminated the additional LEDs 212 incrementally transition in color from yellow to red at 100% wear (e.g., through various hues of yellow, orange, and red). To that end, multicolor LEDs can be used as LEDs 212, such as a red, a green, and a blue (RGB) LED.

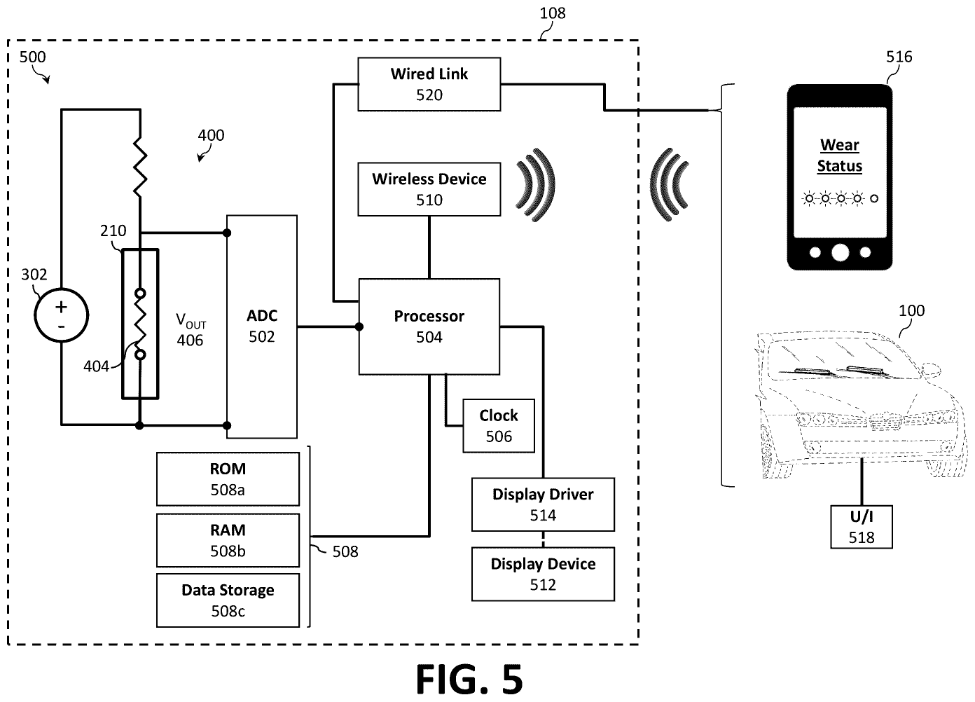

In addition to, or in lieu of, the one or more indicators 216, the wear states (whether good, bad, percentages, or otherwise) can be communicated to another device, such as a portable user device (e.g., smart phone, computer, etc.) or the vehicle 100 (e.g., for display on the dashboard and/or infotainment system). Examples of which will be described in connection with FIG. 5.

FIGS. 3a and 3b illustrate, respectively, schematic representations of an example binary-output blade wear circuit 300 in a first state where the wiping lip 208 is good (e.g., the conductive strip 210 is intact) and in a second state where the wiping lip 208 is bad (e.g., the conductive strip 210 is broken—i.e., not intact). As illustrated, the binary-output blade wear circuit 300 generally comprises a power source 302, the conductive strip 210, at least one LED 212 (serving as an indicator 216), and a resistor (R1) 304.

The power source 302 may be, for example, a direct current (DC) source, such as a battery or the electrical system of the vehicle 100. In one example, the wiper blade 104 can have a small, onboard battery (such as a “button battery”) that serves as the power source 302. In another example, the binary-output blade wear circuit 300 can draw power from the power system of the vehicle 100 to serve as the power source 302, which would typically include an onboard nominal 12-volt battery and an alternator that supplies power at a nominal 12 volts (to power the components of the vehicle 100 and to charge the vehicle battery). In some examples, the onboard battery of the wiper blade 104 can be rechargeable battery (e.g., a lithium battery) and recharged by the nominal 12-volt system of the vehicle 100.

The LED 212 and the resistor (R1) 304 are connected electrically in series with one another, but collectively connected electrically in parallel with each of the power source 302 and the conductive strip 210. In this example, the conductive strip 210 effectively operates as a switch 308. When the conductive strip 210 is intact (i.e., at least partially conductive), power from the power source 302 is able to conduct and, therefore, the conductive strip 210 is, in effect, a closed switch; however, when the conductive strip 210 is broken (i.e., not conductive), power is unable to conduct and, therefore, the conductive strip 210 is, in effect, an open switch.

The binary-output blade wear circuit 300 would be well-suited for indicating, in a binary manner, that the wiping lip 208 is either bad (e.g., damaged and is due for replacement) or is good (e.g., acceptable for continued use). That is, when the conductive strip 210 is intact (i.e., at least partially conductive), power from the power source 302 is able to conduct from the positive terminal of the power source 302 to the negative terminal, thus bypassing (i.e., shunting) the LED 212 and the resistor (R1) 304. As a result, the LED 212 does not illuminate. Conversely, when the conductive strip 210 is not intact (i.e., not conductive), power from the power source 302 is unable to conduct from the positive terminal of the power source 302 to the negative terminal, thus passing through the LED 212 and the resistor (R1) 304. As a result, the LED 212 is illuminated.

FIG. 4 illustrates a schematic representation of a variable-output blade wear circuit 400 in accordance with another aspect of the present disclosure. As illustrated, the variable-output blade wear circuit 400 generally comprises the power source 302, the conductive strip 210, and a resistor (R2) 402. The power source 302, the conductive strip 210, and the resistor (R2) 402 are arranged to form a voltage divider where the conductive strip 210 serves as a second resistor. In this example, the conductive strip 210 effectively operates as a variable resistor 404—changing as wear increases. A voltage divider referenced to ground is created by connecting conductive strip 210 and the resistor (R2) 402 in series as illustrated in FIG. 4. The known input voltage from the power source 302 is applied across the series-connected conductive strip 210 and the resistor (R2) 402 and the output voltage 406 is the voltage across the conductive strip 210. The degree of wear to the wiping lip 208 can be estimated by determining the resistance of the conductive strip 210 (Rₛₜᵣᵢₚ) and correlating it to an estimated wear value (e.g., a percentage) using, for example, a look up table stored to a memory device. That is, as the wiping lip 208 degrades, the conductive strip 210 similarly degrades, leading to electrical conductivity degradation. As the conductive strip 210 becomes damaged, its resistive value is affected. For example, a new wiper blade 104 with a fully intact conductive strip 210 will have a lower resistance compared to a used wiper blade 104 with a damaged conductive strip 210.

The resistance of a new conductive strip 210 (Rₛₜᵣᵢₚ) can be determined using the following equation, where p is the resistivity value of the coating material of the conductive strip 210, A is the cross-sectional area of the conductive strip 210, and L is the length of the of the conductive strip 210:

$${R}_{strip} = ( \frac{p * L}{A} )$$

The resistance of the conductive strip 210 (Rₛₜᵣᵢₚ) can be monitored to detect changes in the cross-sectional area of the conductive strip 210 to estimate wear. In one example, because the voltage of the power source 302 (Vᵢₙ) is known and the resistance of the resistor (R2) 402 (R) is known, the real-time (or near real-time) resistance of the conductive strip 210 (Rₛₜᵣᵢₚ) can be determined in real-time or near real-time by measuring the output voltage 406 (Vₒᵤₜ) and using the following equation:

$${V}_{out} = ( \frac{{R}_{strip}}{R * {R}_{strip}} ) * {V}_{in}$$

To mitigate the effects of the environment (e.g., rain, snow, etc.) on the measurements, the resistance of the conductive strip 210 (Rₛₜᵣᵢₚ) can be measured multiple times during a time period and averaged to provide a more robust measured resistance value. In one example, a time-average algorithm can be used to calculate a time-weighted average of the resistance of the conductive strip 210 (Rₛₜᵣᵢₚ). Unlike an algorithm that simply divides the sum of the values in the sample by the number of values, the time-average algorithm takes into account the amount of time between value changes to yield an average value that is more indicative of the actual resistance of the conductive strip 210 (Rₛₜᵣᵢₚ) and is less influenced by a small number of unusual, fleeting values.

FIG. 5 illustrates a schematic representation of a blade-wear system 500 in accordance with an aspect of the present disclosure. As illustrated, the variable-output blade wear circuit 400 generally comprises an analog-to-digital converter (ADC) 502, a processor 504 (e.g., a microprocessor, a central processing unit (CPU), etc.), one or more memory devices 508, a wireless device 510, a wired link 520, a display device 514, and/or display driver 516. As illustrated, the blade-wear system 500 may be configured to communicate, via the wireless device 510 and/or the wired link 520, with one or more other devices, such as a portable user device 516 (e.g., smart phone, computer, etc.) or a user-interface 518 of the vehicle 100. The user-interface 518 can be, for example, the instrument cluster, dashboard, infotainment system, etc. Therefore, the processor 504 may be configured to communicate an indication of the physical condition to a portable user device 516 or vehicle 100.

The processor 504 is configured to control the various operations of the blade-wear system 500. The processor 504 may be operatively coupled to the one or more memory devices 508, such as a read-only memory (ROM) 508a for receiving one or more instruction sets, a random access memory (RAM) 508b having a plurality of buffers for temporarily storing and retrieving information, and to an internal data storage device 508c (e.g., a hard drive, such a solid state drive, or other non-volatile data storage device, such as flash memory). A clock 506 is also coupled to the processor 504 for providing clock or timing signals or pulses thereto. Those skilled in the art will understand that the blade-wear system 500 includes one or more bus structures for interconnecting its various components. As illustrated, the processor 504 may be operatively coupled to a display device 512 via a display driver 514.

The display device 512 can serve as an indicator 216. The display device 512 may comprise, or otherwise employ, one or more light emitting diodes (LEDs), a liquid crystal display (LCD) screen, an organic light-emitting diode (OLED or organic LED) screen, and/or electronic ink (E-ink) displays. The LCD/OLED screen may be an alphanumeric segmented display, or a matrix display, such as those used on portable electronic devices.

The ADC 502 is configured to convert analog signals at the output voltage 406 (Vₒᵤₜ) of the blade-wear system 500 into a digital data value for use and processing by the processor 504. While the blade-wear system 500 is illustrated as receiving an input value (i.e., output voltage 406 (Vₒᵤₜ)) from the variable-output blade wear circuit 400, the blade-wear system 500 could alternatively or additionally be configured to receive an input value from another desired blade wear circuits, such as the binary-output blade wear circuit 300. For example, a voltage measurement across the LED 212 could be used as an input to the ADC 502. In another example, the LED 212 could be omitted (e.g., where a visual indicator isn't need) and a voltage measurement across resistor (R1) 304 could be used as an input to the ADC 502. with a resistor of a known or otherwise).

The wireless device 510 may be configured to manage communication and/or transmission of signals or data between the processor 504 and another device (e.g., the portable electronic device 516 via a communication network or directly with a portable electronic device 516) by way of a wireless transceiver. The wireless device 510 may be a wireless transceiver configured to communicate via one or more wireless standards such as Bluetooth (e.g., short-wavelength, Ultra-High Frequency (UHF) radio waves in the Industrial, Scientific, and Medical (ISM) band from 2.4 to 2.485 GHZ), near-field communication (NFC), Wi-Fi (e.g., Institute of Electrical and Electronics Engineers (IEEE) 802.11 standards), etc. In certain aspects, a wired link 520 may be provided to manage communication and/or transmission of signals or data between the processor 504 and another device, such as the vehicle 100.

For purposes of illustration, the various components of the blade-wear system 500 are illustrated as being housed in or integrated with the wiper blade 104. Indeed, to increase ease of use for the consumer (e.g., enabling the consumer to retrofit a vehicle 100), the various components of the blade-wear system 500 may be housed in the wiper blade 104. Alternatively, to reduce cost of replacement wiper blades, for example, it may be desirable to integrate certain components or functionality with the vehicle 100. To that end, it is contemplated that certain components or functionality of the blade-wear system 500 may be provided via the vehicle 100. As noted above, for example, the power source 302 could be the electrical system of the vehicle 100 to obviate the need for a second battery, but other components could also be integrated. In one example, all components of the blade-wear system 500 could be integrated with the vehicle 100 (other than the conductive strip 210) thus minimizing complexity and cost of the wiper blade 104. Further, while a single component may be illustrated, the described functionality may be distributed across multiple components.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A wiper blade comprising:
a frame structure;
a squeegee coupled to the frame structure, wherein the squeegee comprises a wiping lip; and
a conductive strip formed on a side wall of the wiping lip, wherein the conductive strip extends along a length of the wiping lip.

2. The wiper blade of claim 1, further comprising an indicator configured to indicate a physical condition of the wiping lip.

3. The wiper blade of claim 2, further comprising a power source configured to pass power through the conductive strip.

4. The wiper blade of claim 3, further comprising a resistor (R1) connected electrically in series with the indicator, the indicator and the resistor (R1) being connected electrically in parallel with each of the power source and the conductive strip.

5. The wiper blade of claim 4, the conductive strip is arranged to shunt the indicator and the resistor (R1).

6. The wiper blade of claim 2, wherein the indicator comprises a light emitting diode (LED).

7. The wiper blade of claim 1, further comprising a resistor (R2) connected electrically in series with the conductive strip to form a voltage divider with a power source.

8. The wiper blade of claim 1, wherein at least the wiping lip is replaceable.

9. The wiper blade of claim 1, wherein the conductive strip comprises a conductive material comprising at least one of carbon, graphene, or carbon nanotube.

10. A blade-wear system comprising:
a wiper blade comprising a squeegee and a conductive strip formed on a wiping lip of the squeegee, wherein the conductive strip extends along a length of the wiping lip;
a processor configured to determine a physical condition of the wiping lip as a function of a resistance value of the conductive strip; and
an indicator configured to indicate the physical condition of the wiping lip.

11. The blade-wear system of claim 10, wherein the processor configured to determine the physical condition of the wiping lip in real time or near-real time.

12. The blade-wear system of claim 10, further comprising a resistor (R1) connected electrically in series with the indicator, the indicator and the resistor (R1) being connected electrically in parallel with each of a power source and the conductive strip.

13. The blade-wear system of claim 12, wherein the indicator is configured to indicate the physical condition of the wiping lip in a binary manner.

14. The blade-wear system of claim 10, further comprising a resistor (R2) connected electrically in series with the conductive strip to form a voltage divider with a power source.

15. The blade-wear system of claim 14, wherein the indicator is configured to indicate the physical condition of the wiping lip in an incremental manner.

16. The blade-wear system of claim 14, wherein the wiper blade comprises the indicator.

17. The blade-wear system of claim 10, wherein the processor is configured to communicate, via a wireless device, an indication of the physical condition to a portable user device.

18. A wiper blade comprising:
a squeegee having a wiping lip;
a conductive strip formed on a side wall of the wiping lip, wherein the conductive strip extends along a length of the wiping lip; and
an indicator configured to indicate a physical condition of the wiping lip.

19. The wiper blade of claim 18, further comprising a resistor (R1) connected electrically in series with the indicator, the indicator and the resistor (R1) being connected electrically in parallel with each of a power source and the conductive strip.

20. The wiper blade of claim 18, wherein the indicator comprises a light emitting diode (LED).
